(19) United States
(12) Patent Application Publication
(10) Pub. No.: US 2017/0150461 A1
(43) Pub. Date: May 25, 2017

(54) Method for Determining Transmission Time, Terminal, Base Station, System and Storage Medium

(71) Applicant: ZTE CORPORATION, Shenzhen City, Guangdong Province (CN)

(72) Inventors: Chunxu LI, Shenzhen (CN); Senbao GUO, Shenzhen (CN); Guanghui YU, Shenzhen (CN)

(21) Appl. No.: 15/310,103

(22) PCT Filed: Oct. 13, 2014
(86) PCT No.: PCT/CN2014/088511

§ 371 Date: Dec. 13, 2016

(30) Foreign Application Priority Data
May 13, 2014 (CN) 201410201631.X

(51) Int. Cl. H04W 56/00; H04W 48/16

(52) U.S. Cl. CPC H04W 56/001; H04W 48/16

(57) ABSTRACT

The present document discloses a method for determining a transmission time of a synchronization signal, a terminal, a base station, and a communication system. The method for determining the transmission time of the synchronization signal includes: receiving the synchronization signal; acquiring a time index of the synchronization signal; and determining the transmission time of the synchronization signal according to the time index. The present document also discloses a computer storage medium.

### TECHNICAL FIELD

The present document relates to a synchronization technology in the field of communications, and in particular to a method for determining a transmission time of a synchronization signal, a terminal, a base station, a system, and a storage medium.

### BACKGROUND OF THE RELATED ART

In a communication process, in order to make it convenient for a terminal to access a network, via a base station, for information interaction with other terminals or network devices, the terminal needs to synchronize with the base station. The synchronization includes time synchronization and frequency synchronization. Besides, the terminal probably needs to detect a discovery signal to obtain optimal beam index information. However, with the development of a communication technology, there are more and more signals and signalings in interaction between the terminal and the base station, and requirements for synchronization accuracy are increasingly high. Thus, under a communication environment where current communication is increasingly complicated, how to realize synchronization between the terminal and the base station and how to improve the synchronization accuracy between the terminal and the base station are the problems to be urgently solved in existing technologies.

### SUMMARY

In view of this, the present document is intended to provide a method for determining a transmission time of a synchronization signal, a terminal, a base station, a communication system, and a storage medium, to realize synchronization between a terminal and a base station.

To this end, the technical solutions of the embodiments of the present document are implemented as follows.

The first aspect of the embodiments of the present document provides a method for determining a transmission time of a synchronization signal, including:

receiving a synchronization signal;

acquiring a time index of the synchronization signal; and

determining a transmission time of the synchronization signal according to the time index.

Alternatively,

the time index is a first time index, a second time index, a third time index, a fourth time index, a fifth time index, a sixth time index or a seventh time index;

acquiring a time index of the synchronization signal is:

acquiring the first time index transmitted by a base station via a system message, a dedicated signaling or a high layer signaling;

or

acquiring the second time index according to a synchronization signal transmitted by the base station;

or

acquiring the third time index according to a discovery signal transmitted by the base station;

or

acquiring the fourth time index according to the synchronization signal and the discovery signal transmitted by the base station;

or

acquiring the fifth time index according to the first time index and the second time index;

or

acquiring the sixth time index according to the first time index and the third time index;

or

acquiring the seventh time index according to the first time index and the fourth time index.

Alternatively,

acquiring the first time index transmitted by a base station via the system message is:

determining the first time index according to a corresponding relationship, configured by the high layer signaling or predefined, between a scrambling bit sequence of the system message and the first time index;

or

determining the first time index according to a corresponding relationship, configured by the high layer signaling or predefined, between a Cyclic Redundancy Check, CRC, scrambling bit sequence of the system message and the first time index;

or

determining the first time index according to a corresponding relationship, configured by the high layer signaling or predefined, between a combination of the CRC scrambling bit sequence of the system message and the scrambling bit sequence of the system message and the first time index;

or

determining the first time index according to a corresponding relationship, configured by the high layer signaling or predefined, between a combination of the CRC scrambling bit sequence of the system message and a system message bit and the first time index;

or

determining the first time index according to a corresponding relationship, configured by the high layer signaling or predefined, between a combination of the scrambling bit sequence of the system message and the system message bit and the first time index;

or

determining the first time index according to a corresponding relationship, configured by the high layer signaling or predefined, between a combination of the CRC scrambling bit sequence of the system message, the scrambling bit sequence of the system message and the system message bit and the first time index;
or

determining the first time index according to a corresponding relationship, configured by the high layer signaling or predefined, between the system message bit and the first time index.

Alternatively,

the synchronization signal includes a main synchronization signal and an auxiliary synchronization signal;

receiving a synchronization signal is:

receiving the main synchronization signal and the auxiliary synchronization signal respectively;

acquiring the second time index according to a synchronization signal transmitted by the base station includes:

determining a transmission time interval between the main synchronization signal and the auxiliary synchronization signal according to a receiving time interval between the main synchronization signal and the auxiliary synchronization signal, herein the transmission time interval is a first time interval; and

determining the second time index according to a corresponding relationship, configured by the high layer signaling or predefined, between the first time interval and the second time index.

Alternatively,

N1 synchronization signals use S1 different synchronization sequences, herein N1≧S1>0; and

acquiring the second time index according to a synchronization signal transmitted by the base station includes:

extracting a synchronization sequence corresponding to the synchronization signal; and

determining the second time index according to a corresponding relationship, configured by the high layer signaling or predefined, between the synchronization sequence and the second time index.

Alternatively,

acquiring the third time index according to a discovery signal transmitted by the base station includes:

receiving the discovery signal;

extracting a discovery sequence corresponding to the discovery signal; and

determining the third time index according to a corresponding relationship, configured by the high layer signaling or predefined, between the discovery sequence and the third time index;

herein N2 discovery signals use S2 different discovery sequences, and N2≧S2>0.

Alternatively,

acquiring the third time index according to a discovery signal transmitted by the base station includes:

receiving the discovery signal, herein the discovery signal bears a beam index; and

determining the third time index according to a corresponding relationship, configured by the high layer signaling or predefined, between the beam index and the third time index.

Alternatively,

the method further includes: receiving the discovery signal;

acquiring the fourth time index according to the synchronization signal and the discovery signal transmitted by the base station includes:

determining a transmission time interval between the synchronization signal and the discovery signal according to a receiving time interval between the synchronization signal and the discovery signal, herein the transmission time interval is a second time interval;

determining the fourth time index according to a corresponding relationship, configured by the high layer signaling or predefined, between the second time interval of the synchronization signal and the discovery signal and the second time index;

or

determining a synchronization signal index according to the synchronization signal;

determining a discovery signal index according to the discovery signal;

determining the fourth time index according to a corresponding relationship, configured by the high layer signaling or predefined, between a combination of a synchronization serial number index and the discovery signal index and the fourth time index;

or,

determining the synchronization signal index according to the synchronization signal;

determining the discovery signal index according to the discovery signal;

determining the transmission time interval between the synchronization signal and the discovery signal, herein the time interval is the second time interval; and

determining the fourth time index according to a corresponding relationship, configured by the high layer signaling or predefined, between a combination of a synchronization signal sequence index, the discovery signal index and the second time interval and the second time index.

Alternatively,

the time index includes at least one of the following indexes: a transmission symbol index, a micro-frame index, a sub-frame index and a time domain unit index.

The second aspect of the embodiments of the present document provides a method for determining a transmission time of a synchronization signal, including:

transmitting the synchronization signal; and

transmitting a first time index of the synchronization signal,

herein the first time index is arranged to determine the transmission time of the synchronization signal.

Alternatively,

transmitting a first time index of the synchronization signal is:

transmitting the first time index via a system message, dedicated information or a high layer signaling.

Alternatively,

transmitting the first time index via the system message is:

determining the first time index according to a corresponding relationship, configured by the high layer signaling or predefined, between a scrambling bit sequence of a scrambling bit sequence system message of the system message and the first time index, and transmitting the first time index borne in the system message;

or

determining the first time index according to a corresponding relationship, configured by the high layer signaling or predefined, between a CRC scrambling bit sequence of the system message and the first time index, and transmitting the first time index borne in the system message;

or

determining the first time index according to a corresponding relationship, configured by the high layer signaling or predefined, between a combination of the CRC scrambling bit sequence of the system message and the scrambling bit sequence of the system message and the first time index, and transmitting the first time index borne in the system message;

or

determining the first time index according to a corresponding relationship, configured by the high layer signaling or predefined, between a combination of the CRC scrambling bit sequence of the system message and a system message bit and the first time index, and transmitting the first time index borne in the system message;

or

determining the first time index according to a corresponding relationship, configured by the high layer signaling or predefined, between a combination of the scrambling bit sequence of the system message and the system message bit and the first time index, and transmitting the first time index borne in the system message;

or

determining the first time index according to a corresponding relationship, configured by the high layer signaling or predefined, between a combination of the CRC scrambling bit sequence of the system message, the scrambling bit sequence of the system message and the system message bit and the first time index, and transmitting the first time index borne in the system message;

or

determining the first time index according to a corresponding relationship, configured by the high layer signaling or predefined, between the system message bit and the first time index, and transmitting the first time index borne in the system message.

The third aspect of the embodiments of the present document provides a method for determining a transmission time of a synchronization signal, including:

determining a transmission parameter according to a corresponding relationship between different synchronization signals and time indexes; and

transmitting a downlink signal including the synchronization signal according to the transmission parameter,

herein the transmission parameter is arranged to represent the time index; and

the time index is a time index arranged for a terminal to determine a transmission time of the synchronization signal.

Alternatively,

the time index is a second time index;

the synchronization signal includes a main synchronization signal and an auxiliary synchronization signal;

a transmission time interval between the main synchronization signal and the auxiliary synchronization signal is a first time interval;

the transmission parameter is the first time interval; the time index is the second time index; and

the first time interval is represented as the second time index;

herein a corresponding relationship between the first time interval and the second time index is configured by a high layer signaling or predefined.

Alternatively,

N1 synchronization signals use S1 different synchronization sequences, herein N1≧S1>0;

the transmission parameter is the synchronization sequence, and the time index is the second time index,

herein a corresponding relationship between the synchronization sequence and the second time index is configured by the high layer signaling or predefined.

Alternatively, the downlink signal further includes a discovery signal;

the transmission parameter is a beam index borne by the discovery signal; the time index is a third time index;

a corresponding relationship between the beam index and the third time index is configured by the high layer signaling or predefined.

Alternatively,

the downlink signal further includes a discovery signal;

the transmission parameter is a discovery sequence of the discovery signal; the time index is a third time index;

a corresponding relationship between the discovery sequence and the third time index is configured by the high layer signaling or predefined.

Alternatively, the downlink signal further includes a discovery signal;

a transmission time interval between the synchronization signal and the discovery signal is the second time interval;

the transmission parameter is the second time interval; the time index is a fourth time index;

a corresponding relationship between the second time interval and the fourth time index is configured by the high layer signaling or predefined;

or

the transmission parameter is a synchronization signal index of the synchronization signal and a discovery signal index of the discovery signal; the time index is the fourth time index;

a corresponding relationship between a combination of the synchronization signal index and the discovery signal index and the fourth time index is configured by the high layer signaling or predefined;

or

the transmission parameter includes the synchronization signal index, the discovery signal index and the second time interval;

the time index is the fourth time index;

a corresponding relationship between a combination of the synchronization signal index, the discovery signal index and the second time interval and the fourth time index is configured by the high layer signaling or predefined.

Alternatively,

the method further includes: transmitting a first time index in the time indexes via a system message, a dedicated signaling or a high layer signaling,

the first time index and other time indexes in the time indexes are time indexes cooperatively arranged for a terminal to determine the transmission time of the synchronization signal.

The fourth aspect of the embodiments of the present document provides a method for determining a transmission time of a synchronization signal, the method for determining a transmission time of the synchronization signal includes:

transmitting, by a base station, a synchronization signal;

receiving, by a terminal, the synchronization signal;

transmitting, by the base station, a first time index; herein the first time index is arranged to indicate the transmission time of the synchronization signal;

receiving, by the terminal, the first time index; and

determining, by the terminal, the transmission time of the synchronization signal according to the first time index.

The fifth aspect of the embodiments of the present document provides a method for determining a transmission time of a synchronization signal, the method for determining a transmission time of the synchronization signal includes:

determining, by a base station, a transmission parameter according to a corresponding relationship between different synchronization signals and time indexes;

transmitting, by the base station, a downlink signal including the synchronization signal according to the transmission parameter;

herein the transmission parameter is arranged to represent the time index; and

the time index is a time index arranged for the terminal to determine the transmission time of the synchronization signal;

receiving, by the terminal, the downlink signal including the synchronization signal;

acquiring, by the terminal, the transmission parameter of the downlink signal, and determining the time index according to the transmission parameter; and

determining, by the terminal, the transmission time of the synchronization signal according to the time index.

The sixth aspect of the embodiments of the present document provides a terminal, including:

a receiving unit, arranged to receive a synchronization signal;

an acquisition unit, arranged to acquire a time index of the synchronization signal; and

a first determination unit, arranged to determine a transmission time of the synchronization signal according to the time index.

Alternatively,

the time index is a first time index, a second time index, a third time index, a fourth time index, a fifth time index, a sixth time index or a seventh time index;

the acquisition unit is arranged to:

acquire the first time index transmitted by a base station via a system message, a dedicated signaling or a high layer signaling;

or

acquire the second time index according to a synchronization signal transmitted by the base station;

or

acquire the third time index according to a discovery signal transmitted by the base station;

or

acquire the fourth time index according to the synchronization signal and the discovery signal transmitted by the base station;

or

acquire the fifth time index according to the first time index and the second time index;

or

acquire the sixth time index according to the first time index and the third time index;

or

acquire the seventh time index according to the first time index and the fourth time index.

Alternatively,

the acquisition unit is arranged to:

determine the first time index according to a corresponding relationship, configured by the high layer signaling or predefined, between a scrambling bit sequence of the system message and the first time index;

or

determine the first time index according to a corresponding relationship, configured by the high layer signaling or predefined, between a CRC scrambling bit sequence of the system message and the first time index;

or

determine the first time index according to a corresponding relationship, configured by the high layer signaling or predefined, between a combination of the CRC scrambling bit sequence of the system message and the scrambling bit sequence of the system message and the first time index;

or

determine the first time index according to a corresponding relationship, configured by the high layer signaling or predefined, between a combination of the CRC scrambling bit sequence of the system message and a system message bit and the first time index;

or

determine the first time index according to a corresponding relationship, configured by the high layer signaling or predefined, between a combination of the scrambling bit sequence of the system message and the system message bit and the first time index;

or

determine the first time index according to a corresponding relationship, configured by the high layer signaling or predefined, between a combination of the CRC scrambling bit sequence of the system message, the scrambling bit sequence of the system message and the system message bit and the first time index;

or

determine the first time index according to a corresponding relationship, configured by the high layer signaling or predefined, between the system message bit and the first time index.

Alternatively,

the synchronization signal includes a main synchronization signal and an auxiliary synchronization signal;

the receiving unit is arranged to receive the main synchronization signal and the auxiliary synchronization signal respectively;

the acquisition unit is arranged to: determine a transmission time interval between the main synchronization signal and the auxiliary synchronization signal according to a receiving time interval between the main synchronization signal and the auxiliary synchronization signal, herein the transmission time interval is a first time interval; and determine the second time index according to a corresponding relationship, configured by the high layer signaling or predefined, between the first time interval and the second time index.

Alternatively,

N1 synchronization signals use S1 different synchronization sequences, herein N1≧S1>0;

the acquisition unit is arranged to: extract a synchronization sequence corresponding to the synchronization signal; and determine the second time index according to a corresponding relationship, configured by the high layer signaling or predefined, between the synchronization sequence and the second time index.

Alternatively,

the acquisition unit is arranged to: receive a discovery signal; extract a discovery sequence corresponding to the discovery signal; and determine the third time index according to a corresponding relationship, configured by the high layer signaling or predefined, between the discovery sequence and the third time index;

herein N2 discovery signals use S2 different discovery sequences, and N2≧S2>0.

Alternatively,

the acquisition unit is arranged to: receive a discovery signal, the discovery signal bearing a beam index; and determine the third time index according to a corresponding relationship, configured by the high layer signaling or predefined, between the beam index and the third time index.

Alternatively,

the acquisition unit is arranged to: receive a discovery signal; determine a transmission time interval between the synchronization signal and the discovery signal according to a receiving time interval between the synchronization signal and the discovery signal, herein the transmission time interval is a second time interval; and determine the fourth time index according to a corresponding relationship, configured by the high layer signaling or predefined, between the second time interval of the synchronization signal and the discovery signal and the fourth time index;

or

determine a synchronization signal index according to the synchronization signal; determine the discovery signal index according to the discovery signal; and determine the fourth time index according to a corresponding relationship, configured by the high layer signaling or predefined, between a combination of the synchronization signal index and the discovery signal index and the fourth time index;

or

determine the synchronization signal index according to the synchronization signal;

determine the discovery signal index according to the discovery signal; and determine the transmission time interval between the synchronization signal and the discovery signal, herein the time interval is the second time interval; and

determine the fourth time index according to a corresponding relationship, configured by the high layer signaling or predefined, between a combination of a synchronization signal sequence index, the discovery signal index and the second time interval and the second time index.

Alternatively,

the time index includes at least one of the following indexes: a transmission symbol index, a micro-frame index, a sub-frame index and a time domain unit index.

The seventh aspect of the embodiments of the present document provides a base station, including:

a first transmission unit, arranged to transmit a synchronization signal and a first time index,

herein the first time index is arranged for a terminal to determine a transmission time of the synchronization signal.

Alternatively,

the first transmission unit is arranged to transmit the first time index via a system message, dedicated information or a high layer signaling.

Alternatively,

the first transmission unit is arranged to: determine the first time index according to a corresponding relationship, configured by the high layer signaling or predefined, between a scrambling bit sequence of a scrambling bit sequence system message of the system message and the first time index, and transmit the first time index borne in the system message;

or

determine the first time index according to a corresponding relationship, configured by the high layer signaling or predefined, between a CRC scrambling bit sequence of the system message and the first time index, and transmit the first time index borne in the system message;

or

determine the first time index according to a corresponding relationship, configured by the high layer signaling or predefined, between a combination of the CRC scrambling bit sequence of the system message and the scrambling bit sequence of the system message and the first time index, and transmit the first time index borne in the system message;

or

determine the first time index according to a corresponding relationship, configured by the high layer signaling or predefined, between a combination of the CRC scrambling bit sequence of the system message and a system message bit and the first time index, and transmit the first time index borne in the system message;

or

determine the first time index according to a corresponding relationship, configured by the high layer signaling or predefined, between a combination of the scrambling bit sequence of the system message and the system message bit and the first time index, and transmit the first time index borne in the system message;

or

determine the first time index according to a corresponding relationship, configured by the high layer signaling or predefined, between a combination of the CRC scrambling bit sequence of the system message, the scrambling bit sequence of the system message and the system message bit and the first time index, and transmit the first time index borne in the system message;

or

determine the first time index according to a corresponding relationship, configured by the high layer signaling or predefined, between the system message bit and the first time index, and transmit the first time index borne in the system message.

The eighth aspect of the embodiments of the present document provides a base station, including:

a second determination unit, arranged to determine a transmission parameter according to a corresponding relationship between different synchronization signals and time indexes;

a second transmission unit, arranged to transmit a downlink signal including the synchronization signal according to the transmission parameter;

herein the transmission parameter is arranged to represent the time index;

the time index is a time index arranged for a terminal to determine a transmission time of the synchronization signal.

Alternatively,

the time index is a second time index;

the synchronization signal includes a main synchronization signal and an auxiliary synchronization signal;

a transmission time interval between the main synchronization signal and the auxiliary synchronization signal is a first time interval;

the transmission parameter is the first time interval; the time index is the second time index; and

the first time interval is represented as the second time index;

herein a corresponding relationship between the first time interval and the second time index is configured by a high layer signaling or predefined.

Alternatively,

N1 synchronization signals use S1 different synchronization sequences, where N1≧S1>0;

the transmission parameter is the synchronization sequence, and the time index is a second time index,

herein a corresponding relationship between the synchronization sequence and the second time index is configured by the high layer signaling or predefined.

Alternatively,

the downlink signal further includes a discovery signal; the transmission parameter is a beam index borne by the discovery signal; the time index is a third time index;

a corresponding relationship between the beam index and the third time index is configured by the high layer signaling or predefined.

Alternatively,

the downlink signal further includes a discovery signal;

the transmission parameter is a discovery sequence of the discovery signal; the time index is a third time index; and

a corresponding relationship between the discovery sequence and the third time index is configured by the high layer signaling or predefined.

Alternatively,

the downlink signal further includes a discovery signal;

a transmission time interval between the synchronization signal and the discovery signal is a second time interval;

the transmission parameter is the second time interval; the time index is a fourth time index;

a corresponding relationship between the second time interval and the fourth time index is configured by the high layer signaling or predefined;

or

the transmission parameter is a synchronization signal index of the synchronization signals and a discovery signal index of the discovery signal; the time index is the fourth time index;

a corresponding relationship between a combination of the synchronization signal index and the discovery signal index and the fourth time index is configured by the high layer signaling or predefined;

or

the transmission parameter includes the synchronization signal index, the discovery signal index and the second time interval;

the time index is the fourth time index;

a corresponding relationship between a combination of the synchronization signal index, the discovery signal index and the second time interval and the fourth time index is configured by the high layer signaling or predefined.

Alternatively,

the second transmission unit is further arranged to transmit a first time index in the time indexes via a system message, a dedicated signaling or a high layer signaling,

the first time index and other time indexes in the time indexes are time indexes cooperatively arranged for the terminal to determine the transmission time of the synchronization signal.

The ninth aspect of the embodiments of the present document provides a communication system, including:

a base station, arranged to transmit a synchronization signal and a first time index; herein the first time index is arranged to indicate transmission time of the synchronization signal; and

a terminal, arranged to receive the synchronization signal and the first time index and determine the transmission time of the synchronization signal according to the first time index.

The tenth aspect of the embodiments of the present document provides a communication system, including:

a base station, arranged to determine a transmission parameter according to a corresponding relationship between different synchronization signals and time indexes, and transmit a downlink signal including the synchronization signal according to the transmission parameter; herein the transmission parameter is arranged to represent the time index, and the time index is a time index arranged for a terminal to determine a transmission time of the synchronization signal; and

the terminal, arranged to receive the downlink signal including the synchronization signal; acquire the transmission parameter of the downlink signal, determine the time index according to the transmission parameter; and determine the transmission time of the synchronization signal according to the time index.

The tenth aspect of the embodiments of the present document provides a computer storage medium, computer executable instructions are stored in the computer storage medium, the computer executable instructions are arranged to execute at least one of the methods of the first aspect to the fifth aspect of the embodiments of the present document.

The embodiments of the present document provide the method for determining the transmission time of the synchronization signal, the terminal, the base station, the communication system, and the storage medium. The terminal not only receives the synchronization signal, but also acquires the time index of the synchronization signal, such that more accurate synchronization time of the synchronization signal may be obtained, and when applied to the terminal, the base station or the communication system capable of receiving a plurality of synchronization signals within a synchronization period, the terminal will determine the transmission time of each synchronization signal according to the time index of each synchronization signal, thereby solving the problem in the existing technology that a terminal, within synchronization periods, only knows within which synchronization period a synchronization signal is located, but cannot accurately learn that the synchronization signal is located in which sub-frame, micro-frame or transmission symbol. Thus, the synchronization accuracy between the terminal and the base station is improved, so as to facilitate completion of synchronization between the terminal and the base station in conjunction with two pieces of information such as a time index and a synchronization signal.

### BRIEF DESCRIPTION OF DRAWINGS

FIG. 1 is flowchart 1 of a method for determining a transmission time of a synchronization signal according to an embodiment of the present document;

FIG. 2 is flowchart 2 of a method for determining the transmission time of the synchronization signal according to an embodiment of the present document;

FIG. 3 is flowchart 3 of a method for determining the transmission time of the synchronization signal according to an embodiment of the present document;

FIG. 4 is flowchart 4 of a method for determining the transmission time of the synchronization signal according to an embodiment of the present document;

FIG. 5 is flowchart 5 of a method for determining the transmission time of the synchronization signal according to an embodiment of the present document;

FIG. 6 is a schematic diagram of the structure of the terminal according to an embodiment of the present document;

FIG. 7 is schematic diagram 1 of the structure of the base station according to an embodiment of the present document;

FIG. 8 is schematic diagram 2 of the structure of the base station according to an embodiment of the present document; and

FIG. 9 is a schematic diagram of a corresponding relationship between the synchronization signal and time according to an embodiment of the present document.

### SPECIFIC EMBODIMENTS

Optional embodiments of the present document are elaborated below in conjunction with the accompanying drawings. It will be appreciated that the optional embodiments elaborated below are only intended to illustrate and explain the present document, and do not limit the present document.

### Embodiment 1

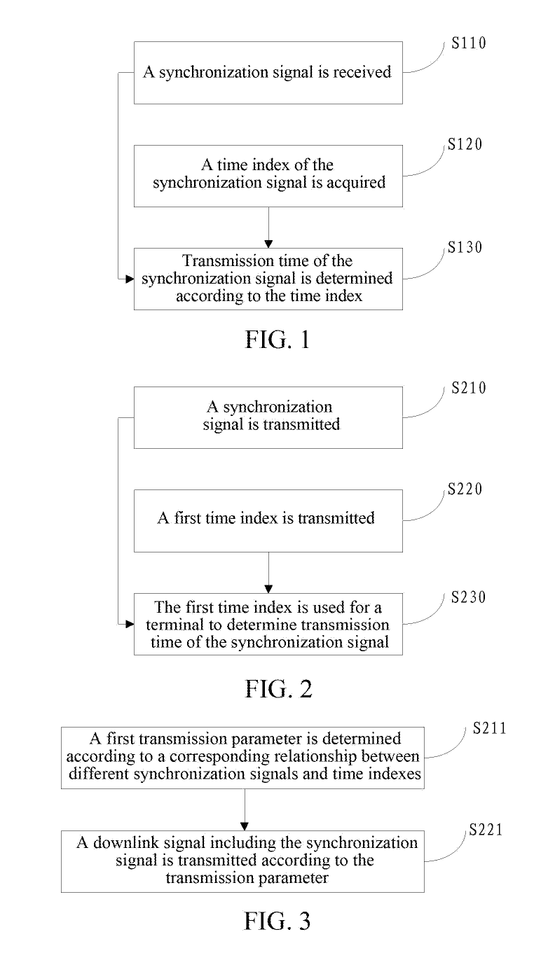

As shown in FIG. 1, this embodiment provides a method for determining a transmission time of a synchronization signal, the method including the following steps:

in step S110, a synchronization signal is received;

in step S120, a time index of the synchronization signal is acquired;

in step S130, a transmission time of the synchronization signal is determined according to the time index.

A terminal may receive at least two synchronization signals within one synchronization period; specifically, for example, a plurality of different synchronization signals is received at the same time, and a plurality of identical or different synchronization signals are received at different times. If the terminal receives at least two synchronization signals within one synchronization period, how to determine the transmission time of each synchronization signal is a problem; in this embodiment, the terminal further includes the step of acquiring time indexes corresponding to the synchronization signals. The time indexes are used for determining the transmission times of the synchronization signals; the transmission time may, specifically, be a certain transmission moment, or may correspond to a transmission time period such as a sub-frame, a micro-frame or an Orthogonal Frequency Division Multiplexing (OFDM) symbol or a self-defined time domain unit.

After step S130 is executed, the terminal corrects synchronization with a base station according to the received synchronization signals and the transmission time determined in Step S130, thereby making the synchronization more accurate.

The step S110 and step S120 are not in a certain sequence, and may be executed at the same time, or may be executed sequentially; specifically, step S110 may be prior to step S120, or step S120 may be prior to step S110.

Furthermore,

the time index is a first time index, a second time index, a third time index, a fourth time index, a fifth time index, a sixth time index or a seventh time index. According to different time indexes, there are different methods for acquiring the time index, specifically, for example:

The first time index transmitted by the base station via a system message, a dedicated signaling or a high layer signaling, is acquired.

The second time index is acquired according to a synchronization signal transmitted by the base station.

The third time index is acquired according to a discovery signal transmitted by the base station.

The fourth time index is acquired according to the synchronization signal and the discovery signal transmitted by the base station.

The fifth time index is acquired according to the first time index and the second time index.

The sixth time index is acquired according to the first time index and the third time index.

The seventh time index is acquired according to the first time index and the fourth time index.

The time index may be at least one of a transmission symbol index, a micro-frame index, a sub-frame index and a time domain unit index.

A radio frame may be divided into a plurality of sub-frames; a sub-frame may be divided into a plurality of micro-frames; and a synchronization period generally includes one or more sub-frames.

A transmission symbol may, specifically, be an OFDM symbol; the OFDM symbol is orthogonal frequency division multiplexing symbol corresponding to a certain number of resources of frequency domain and time domain. The transmission symbol index is an index indicative of a specific transmission symbol. Thus, when the first time index is the transmission symbol index, it is indicated that the synchronization signal is transmitted on the transmission symbol, such that time accuracy of synchronization between the base station and the terminal is one transmission symbol; generally, one synchronization period includes a plurality of transmission symbols. It is apparent that the time accuracy corresponding to one transmission symbol is higher than the time accuracy corresponding to one synchronization period.

A time domain unit is a predefined time length, and may include one or more micro-frames or transmission symbols. Synchronization accuracy can be self-determined by self-defining the time domain unit, thereby improving the controllability of a system.

In this embodiment, the first time index is received via the system message, the dedicated signaling or the high layer signaling.

Bearing the first time index in already existing messages or signaling such as a system message, a discovery signal or a high layer signaling in the existing technology will not increase the number of times for the terminal to receive messages from the base station, and may prolong standby time. In a specific time process, the discovery signal and the synchronization signal may be identical signals, or may be different signals transmitted sequentially at, however, very close transmission time, such that the first time index may be transmitted using the discovery signal, thereby making the implementation easier.

The first time index may be represented by a dedicated field or bit map. In this embodiment, in order to reduce overhead of a downlink, the first time index and other messages are composited in the same sequence or the same field, the terminal receiving the first time index includes: receiving the system message, and after the system message is received, it may further include:

determining the first time index according to a corresponding relationship, configured by the high layer signaling or predefined, between a scrambling bit sequence of the system message and the first time index;

or

determining the first time index according to a corresponding relationship, configured by the high layer signaling or predefined, between a CRC scrambling bit sequence of the system message and the first time index;

or

determining the first time index according to a corresponding relationship, configured by the high layer signaling or predefined, between a combination of the CRC scrambling bit sequence of the system message and the scrambling bit sequence of the system message and the first time index;

or

determining the first time index according to a corresponding relationship, configured by the high layer signaling or predefined, between a combination of the CRC scrambling bit sequence of the system message and a system message bit and the first time index;

or

determining the first time index according to a corresponding relationship, configured by the high layer signaling or predefined, between a combination of the scrambling bit sequence of the system message and the system message bit and the first time index;

or

determining the first time index according to a corresponding relationship, configured by the high layer signaling or predefined, between a combination of the CRC scrambling bit sequence of the system message, the scrambling bit sequence of the system message and the system message bit and the first time index;

or

determining the first time index according to a corresponding relationship, configured by the high layer signaling or predefined, between the system message bit and the first time index.

Herein, an original system information bit string is subjected to CRC encoding to form a first system information bit sequence, and then the first system information bit sequence is subjected to channel encoding to form a system information bit sequence, a scrambling sequence used for scrambling the system information bit sequence is the scrambling bit sequence of the system message.

Herein, the original system information bit string is subjected to CRC encoding to form the first system information bit sequence, and a scrambling sequence used for scrambling a CRC bit sequence in a first sequence is the CRC scrambling bit sequence of the system message.

Several alternative methods for acquiring the second time index are provided as follows.

Method 1: the synchronization signal includes a main synchronization signal and an auxiliary synchronization signal;

receiving the synchronization signal is:

receiving the main synchronization signal and the auxiliary synchronization signal respectively;

acquiring the second time index according to the synchronization signal transmitted by the base station includes:

determining a transmission time interval between the main synchronization signal and the auxiliary synchronization signal according to a receiving time interval between the main synchronization signal and the auxiliary synchronization signal; herein the transmission time interval is a first time interval; and

determining the second time index according to a corresponding relationship configured by the high layer signaling or predefined, between the first time interval and the second time index. Herein, alternatively, the first time interval between the main synchronization signal and the auxiliary synchronization signal of different synchronization signals is different.

Method 2: N1 synchronization signals use S1 different synchronization sequences, herein N1≧S1>0;

acquiring the second time index according to the synchronization signal transmitted by the base station includes:

extracting a synchronization sequence corresponding to the synchronization signal; and

determining the second time index according to a corresponding relationship, configured by the high layer signaling or predefined, between the synchronization sequence and the second time index. Herein, in a specific implementation process, a plurality of synchronization signals within a synchronization period optionally use different synchronization sequences.

There are many methods for acquiring the third time index, and several specific methods are provided as follows.

Method 1:

Acquiring the third time index according to the discovery signal transmitted by the base station includes:

receiving the discovery signal;

extracting a discovery sequence corresponding to the discovery signal; and

determining the third time index according to a corresponding relationship, configured by the high layer signaling or predefined, between the discovery sequence and the third time index;

herein N2 discovery signals use S2 different discovery sequences, and N2≧S2>0; and in a specific implementation process, alternatively, different discovery signals correspond to different discovery sequences.

Method 2:

Acquiring the third time index according to the discovery signal transmitted by the base station includes:

receiving the discovery signal, herein the discovery signal bears a beam index; and

determining the third time index according to a corresponding relationship, configured by the high layer signaling or predefined, between the beam index and the third time index. Herein, in a specific implementation process, the beam indexes of the discovery signal corresponding to different synchronization signals are different.

Several alternative modes of acquiring the fourth time index are provided as follows.

Mode 1:

The method further includes receiving the discovery signal;

acquiring the fourth time index according to the synchronization signal and the discovery signal transmitted by the base station includes:

determining the transmission time interval between the synchronization signal and the discovery signal according to the receiving time interval between the synchronization signal and the discovery signal, herein the transmission time interval is a second time interval; and determining the fourth time index according to a corresponding relationship, configured by the high layer signaling or predefined, between the second time interval of the synchronization signal and the discovery signal and the second time index.

Mode 2:

A synchronization signal index is determined according to the synchronization signal;

a discovery signal index is determined according to the discovery signal; and

the fourth time index is determined according to a corresponding relationship, configured by the high layer signaling or predefined, between a combination of the synchronization signal index and the discovery signal index and the fourth time index.

Mode 3:

The synchronization signal index is determined according to the synchronization signal;

the discovery signal index is determined according to the discovery signal;

the transmission time interval between the synchronization signal and the discovery signal is determined; herein the time interval is the second time interval; and

the fourth time index is determined according to a corresponding relationship, configured by the high layer signaling or predefined, between a combination of a synchronization signal sequence index, the discovery signal index and the second time interval and the second time index.

Specifically, the fifth time index is acquired by a way of combining the methods for acquiring the first time index and the second time index; the sixth time index is acquired by a way of combining the methods for acquiring the first time index and the third time index; and the seventh time index is acquired by a way of combining the methods for acquiring the first time index and the fourth time index.

Transmission of a time index using the above methods can reduce a transmission amount of downlink data and can reduce signaling overhead.

In conclusion, this embodiment provides a method for determining a transmission time of a synchronization signal, which determines the transmission time according to the time index, is particularly applicable to a scenario where a plurality of synchronization signals are received at the same time within a synchronization period, and has the advantages of high synchronization accuracy and easy implementation.

### Embodiment 2

As shown in FIG. 2, this embodiment provides a method for determining a transmission time of a synchronization signal, the method including the following steps:

in step S210, the synchronization signal is transmitted;

in step S220, a first time index is transmitted;

in step S230, the first time index is used for a terminal to determine the transmission time of the synchronization signal.

When the synchronization signal is transmitted, generally a plurality of synchronization signals may be transmitted within a synchronization period; specifically, for example, a plurality of different synchronization signals are transmitted at the same time, and a plurality of identical or different synchronization signals are transmitted at different times.

A base station will also transmit the first time index in the step S220 at the same time; specifically, for example, when a synchronization signal A is transmitted, the first time index corresponding to the synchronization signal A will also be transmitted for a terminal to determine the transmission time of the synchronization signal. The transmission time may be a specific moment, or may also be a time period. The first time index may be any information in a corresponding relationship with time.

The step S210 and step S220 are not in a certain sequence; and may be executed at the same time, or may be executed sequentially; specifically, the step S210 may be prior to the step S220, or the step S220 may also be prior to the step S210.

There are many modes of transmitting the first time index. In this embodiment, optionally, the first time index is transmitted via the system message, the dedicated signaling or the high layer signaling.

Furthermore, the first time index may be at least one of the transmission symbol index, the micro-frame index, the sub-frame index and the time domain unit index. The composition of the first time index may refer to corresponding parts in Embodiment 1, which will not be further elaborated herein.

There are many methods for transmitting the first time index in the step S220. In this embodiment, optionally, the first time index is transmitted via the system message, the dedicated signaling, the discovery signal or the high layer signaling.

There are many methods for transmitting the first time index via the system message, and several optional modes are provided as follows.

Transmitting the first time index via the system message is:

Alternative mode 1:

determining the first time index according to the corresponding relationship, configured by the high layer signaling or predefined, between a scrambling bit sequence of a scrambling bit sequence system message of the system message and the first time index, and transmitting the first time index borne in the system message;

Alternative mode 2:

determining the first time index according to the corresponding relationship, configured by the high layer signaling or predefined, between the CRC scrambling bit sequence of the system message and the first time index, and transmitting the first time index borne in the system message;

Alternative mode 3:

determining the first time index according to the corresponding relationship, configured by the high layer signaling or predefined, between the combination of the CRC scrambling bit sequence of the system message and the scrambling bit sequence of the system message and the first time index, and transmitting the first time index borne in the system message;

Alternative mode 4:

determining the first time index according to the corresponding relationship, configured by the high layer signaling or predefined, between the combination of the CRC scrambling bit sequence of the system message and a system message bit and the first time index, and transmitting the first time index borne in the system message;

Alternative mode 5:

determining the first time index according to the corresponding relationship, configured by the high layer signaling or predefined, between the combination of the scrambling bit sequence of the system message and the system message bit and the first time index, and transmitting the first time index borne in the system message;

Alternative mode 6:

determining the first time index according to the corresponding relationship, configured by the high layer signaling or predefined, between the combination of the CRC scrambling bit sequence of the system message, the scrambling bit sequence of the system message and the system message bit and the first time index, and transmitting the first time index borne in the system message;

Alternative mode 7:

determining the first time index according to the corresponding relationship, configured by the high layer signaling or predefined, between the system message bit and the first time index, and transmitting the first time index borne in the system message.

In conclusion, this embodiment provides a base station that transmits the synchronization signal and also transmits the first time index used for determining the transmission time of the synchronization signal at the same time, thereby facilitating achievement of accurate synchronization; moreover, several optional methods for transmitting the first time index are specifically provided, and meanwhile, have the advantages of simple and convenient implementation.

### Embodiment 3

As shown in FIG. 3, this embodiment provides a method for determining a transmission time of a synchronization signal, herein the method includes the following steps:

in step S211, a transmission parameter is determined according to a corresponding relationship between different synchronization signals and time indexes;

in step S221, a downlink signal including the synchronization signal is transmitted according to the transmission parameter,

herein the transmission parameter is used for representing the time index; and

the time index is a time index for a terminal to determine the transmission time of the synchronization signal.

The time index may, at least, includes the second time index, the third time index and the fourth time index.

When the time index is the second time index, two optional modes are provided to realize representing of the second time index as follows.

Mode 1: the synchronization signal includes a main synchronization signal and an auxiliary synchronization signal;

the transmission time interval between the main synchronization signal and the auxiliary synchronization signal is the first time interval;

the transmission parameter is the first time interval; the time index is the second time index; and

the first time interval is represented as the second time index; herein a corresponding relationship between the first time interval and the second time index is configured by the high layer signaling or predefined.

Mode 2:

N1 synchronization signals use S1 different synchronization sequences, herein N1≧S1>0;

the transmission parameter is the synchronization sequence, and the time index is the second time index;

herein the corresponding relationship between the synchronization sequence and the second time index is configured by the high layer signaling or predefined.

In this embodiment, it is easy to represent the second time index using the transmission parameter of different synchronization signals themselves. In a specific implementation process, a base station side may pre-store a corresponding relationship between the transmission parameter of the synchronization signal and the second time index, the second time index is determined, that is, the transmission time of each synchronization signal is determined.

When the time index is the third time index, the downlink signal transmitted in the step S221 further includes a discovery signal; two optional modes for achieving representing of the third time index are as follows.

Mode 1: the transmission parameter is a beam index borne by the discovery signal; the time index is the third time index; and the corresponding relationship between the beam index and the third time index is configured by the high layer signaling or predefined.

Mode 2: the transmission parameter is a discovery sequence of the discovery signal; the time index is the third time index; and the corresponding relationship between the discovery sequence and the third time index is configured by the high layer signaling or predefined.

When the time index is the fourth time index, the downlink signal transmitted in the step S221 further includes the discovery signal; three optional modes for achieving representing of the fourth time index are as follows.

Mode 1:

The transmission time interval between the synchronization signal and the discovery signal is the second time interval;

the transmission parameter is the second time interval; the time index is the fourth time index; and

the corresponding relationships between the second time interval and the fourth time index is configured by the high layer signaling or predefined.

Mode 2:

The transmission parameter is the synchronization signal index of the synchronization signal and the discovery signal index of the discovery signal; the time index is the fourth time index; and

the corresponding relationship between the combination of the synchronization signal index and the discovery signal index and the fourth time index is configured by the high layer signaling or predefined.

Mode 3:

The transmission parameter includes the synchronization signal index, the discovery signal index and the second time interval;

the time index is the fourth time index;

the corresponding relationship between the combination of the synchronization signal index, the discovery signal index and the second time interval and the fourth time index is configured by the high layer signaling or predefined.

Transmission of the time index by the above modes can reduce the signaling overhead, and is easy to implement.

Besides, any one of the above methods in this embodiment further includes transmitting the first time index via at least one of the system message, the dedicated signaling or the high layer signaling.

The specific mode of transmitting the first time index may refer to the mode for the first time index in Embodiment 2.

The first time index together with at least one of the second time index, the third time index and the fourth time index will be used for the terminal to determine the transmission time of the synchronization signal.

The first time index and the second time index jointly constitute the fifth time index; the first time index and the third time index jointly constitute the sixth time index; and the first time index and the fourth time index jointly constitute the seventh time index.

Specifically, for example, the transmission time of a synchronization signal may be represented by four bits; herein the first time index represents two of the bits, and the remaining two bits are represented by the corresponding relationship between the first time interval and the two bits; thus the transmission time of the synchronization signal can be determined in conjunction with the first time index and the first time interval. Besides, one of the first time index and the first time interval may be a primary index, and the other may be a secondary index subordinate to the primary index. The primary index corresponds to a plurality of secondary indexes; the transmission time of the synchronization signal may be specifically determined in conjunction with the primary index and the secondary index.

### Embodiment 4

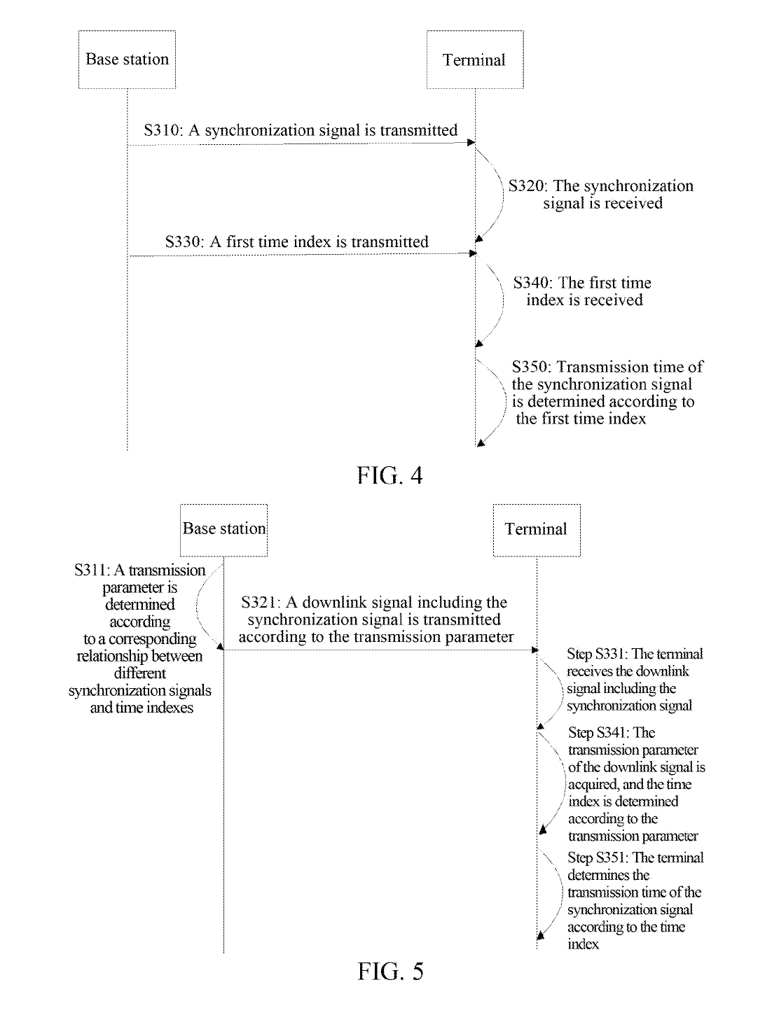

As shown in FIG. 4, this embodiment provides a method for determining a transmission time of a synchronization signal, the method for determining a transmission time of the synchronization signal including the following steps:

in step S310, the base station transmits the synchronization signal;

in step S320, the terminal receives the synchronization signal;

in step S330, the base station transmits the first time index; the first time index is used for indicating the transmission time of the synchronization signal;

in step S340, the terminal receives the first time index;

in step S350, the terminal determines the transmission time of the synchronization signal according to the first time index.

This embodiment combines the technical solutions of Embodiment 1 and the technical solutions of Embodiment 2. The steps executed by the base station may refer to any one of the technical solutions in Embodiment 2, and the steps executed by the terminal may refer to the technical solutions, corresponding to the technical solutions in Embodiment 2, in Embodiment 1. Specifically, for example, the first time index is transmitted via the system message, the discovery signal or the high layer signaling and the like.

In a specific execution process, the step S310 is prior to the step S320, and is prior to the step S350; the step S320 is prior to the step S340, and meanwhile is prior to the step S350; however, the step S320 and the step S320 do not need to follow a sequence order.

After executing the step S350, the terminal will synchronize with the base station according to the determined time, which has the advantages of high synchronization accuracy and easy synchronization implementation.

### Embodiment 5

As shown in FIG. 5, this embodiment provides a method for determining a transmission time of a synchronization signal, the method for determining the transmission time of the synchronization signal including the following steps:

in step S311, the base station determines the transmission parameter according to the corresponding relationship between different synchronization signals and time indexes;

in step S321, the base station transmits the downlink signal including the synchronization signal according to the transmission parameter,

herein the transmission parameter is used for representing the time index; and

the time index is a time index for the terminal to determine the transmission time of the synchronization signal;

in step S331, the terminal receives the downlink signal including the synchronization signal;

in step S341, the terminal acquires the transmission parameter of the downlink signal and determines the time index according to the transmission parameter;

in step S351, the terminal determines the transmission time of the synchronization signals according to the time index.

This embodiment combines the technical solutions of Embodiment 1 and the technical solutions of Embodiment 3. The steps executed by the base station may refer to any one of the technical solutions in Embodiment 3; the steps executed by the terminal may refer to the technical solutions, corresponding to the technical solutions of Embodiment 3, in Embodiment 1. Specifically, for example, the first time index is transmitted via the system message, the discovery signal or the high layer signaling and the like.

Specifically, the transmission parameter may correspond to the first transmission time interval between the main synchronization signal and the auxiliary synchronization signal of one synchronization signal; may also correspond to the second time interval between the synchronization signal and the discovery signal, and may also correspond to the synchronization sequence. The details may refer to Embodiment 3, which will not be elaborated herein.

### Embodiment 6

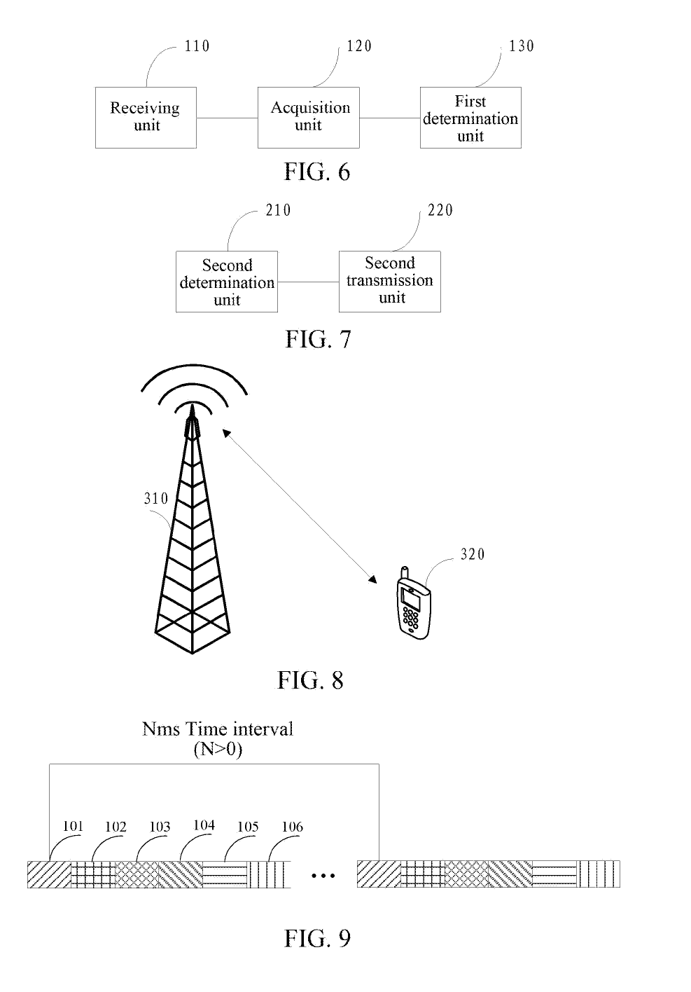

As shown in FIG. 6, this embodiment provides a terminal, the terminal includes:

a receiving unit 110, arranged to receive a synchronization signal;

an acquisition unit 120, arranged to acquire a time index of the synchronization signal; and

a first determination unit 130, arranged to determine a transmission time of the synchronization signal according to the time index.

A receiving interface of the receiving unit 110 is, for example, a receiving antenna.

The acquisition unit 120 varies according to different modes for acquiring the time index, specifically, for example, when the time index is directly received from the base station, a specific structure of the acquisition unit 120 may be a receiving antenna, and may correspond to the same antenna as the receiving unit 110. When the acquisition unit 120 extracts the time index according to the downlink signal received by the receiving unit 110, the specific structure of the acquisition unit 120 may be a processor, and it acquires the transmission parameter of the downlink signal according to an agreement with the terminal in advance, and acquires the time index.

The time index is the first time index, the second time index, the third time index, the fourth time index, the fifth time index, the sixth time index or the seventh time index.

The acquisition unit is arranged to: acquire the first time index transmitted by the base station via the system message, the dedicated signaling or the high layer signaling; or acquire the second time index according to the synchronization signal transmitted by the base station; or acquire the third time index according to the discovery signal transmitted by the base station; or acquire the fourth time index according to the synchronization signal and the discovery signal transmitted by the base station; or acquire the fifth time index according to the first time index and the second time index; or acquire the sixth time index according to the first time index and the third time index; or acquire the seventh time index according to the first time index and the fourth time index.

The acquisition unit 120 is arranged to: determine the first time index according to the corresponding relationship, configured by the high layer signaling or predefined, between the scrambling bit sequence of the system message and the first time index; or determine the first time index according to the corresponding relationship, configured by the high layer signaling or predefined, between the CRC scrambling bit sequence of the system message and the first time index; or determine the first time index according to the corresponding relationship, configured by the high layer signaling or predefined, between a combination of the CRC scrambling bit sequence of the system message and the scrambling bit sequence of the system message and the first time index; or determine the first time index according to the corresponding relationship, configured by the high layer signaling or predefined, between a combination of the CRC scrambling bit sequence of the system message and the system message bit and the first time index; or determine the first time index according to the corresponding relationship, configured by the high layer signaling or predefined, between a combination of the scrambling bit sequence of the system message and the system message bit and the first time index; or determine the first time index according to the corresponding relationship, configured by the high layer signaling or predefined, between a combination of the CRC scrambling bit sequence of the system message, the scrambling bit sequence of the system message and the system message bit and the first time index; or determine the first time index according to the corresponding relationship, configured by the high layer signaling or predefined, between the system message bit and the first time index.

When the time index is the second time index, the method for acquiring the time index at least includes the following two optional modes:

Mode 1:

The synchronization signal includes a main synchronization signal and an auxiliary synchronization signal;

the receiving unit 110 is arranged to receive the main synchronization signal and the auxiliary synchronization signal respectively;

the acquisition unit 120 is arranged to: determine, according to the receiving time interval between the main synchronization signal and the auxiliary synchronization signal, the transmission time interval between the main synchronization signal and the auxiliary synchronization signals, herein the transmission time intervals is the first time interval; and determine the second time index according to the corresponding relationship, configured by the high layer signaling or predefined, between the first time interval and the second time index.

Mode 2:

N1 synchronization signals use S1 different synchronization sequences, herein N1≧S1>0.

The acquisition unit 120 is arranged to: extract the synchronization sequence corresponding to the synchronization signal; and determine the second time index according to the corresponding relationship, configured by the high layer signaling or predefined, between the synchronization sequence and the second time index.

When the time index is the third time index, the method for acquiring the time index by the acquisition unit at least includes the following two optional modes:

Mode 1:

The downlink signal further includes the discovery signal; the transmission parameter is the beam index borne by the discovery signal; the time index is the third time index; and

The corresponding relationship between the beam index and the third time index is configured by the high layer signaling or predefined.

Mode 2:

The transmission parameter is the discovery sequence of the discovery signal; the time index is the third time index; and

the corresponding relationship between the discovery sequence and the third time index is configured by the high layer signaling or predefined.

When the time index is the fourth time index, the method for acquiring the time index by the acquisition unit at least includes the following several optional modes:

Mode 1:

The downlink signal further includes the discovery signal;

the transmission time interval between the synchronization signal and the discovery signal is the second time interval;

the transmission parameter is the second time interval; the time index is the fourth time index; and

the corresponding relationship between the second time interval and the fourth time index is configured by the high layer signaling or predefined.

Mode 2:

The transmission parameter is the synchronization signal index of the synchronization signal and the discovery signal index of the discovery signal; the time index is the fourth time index; and

the corresponding relationship between the combination of the synchronization signal index and the discovery signal index and the second time index is configured by the high layer signaling or predefined.

Mode 3:

The transmission parameter includes the synchronization signal index, the discovery signal index and the second time interval;

the time index is the fourth time index; and

the corresponding relationship between the combination of the synchronization signal index, the discovery signal index and the second time interval and the fourth time index is configured by the high layer signaling or predefined.

Herein, the time index may include at least one of the following indexes: the transmission symbol index, the micro-frame index, the sub-frame index and the time domain unit index.

In conclusion, the terminal of this embodiment provides support hardware for the method for determining the transmission time of the synchronization signal in Embodiment 1, and may be used for implementing the method for determining the transmission time of the synchronization signal in any technical solution in Embodiment 1; besides, after determining the transmission time of various synchronization signals, the terminal will correct synchronization with the base station according to the synchronization signal itself and the transmission time of the synchronization signal, which has the advantages of easy implementation, high synchronization accuracy and the like.

### Embodiment 7

This embodiment provides a base station, the base station includes:

a first transmission unit, arranged to transmit a synchronization signal and a first time index,

herein the first time index is arranged for a terminal to determine a transmission time of the synchronization signal.

A specific structure of the first transmission unit may include a transmission interface, specifically, for example, a transmission antenna or a transmission antenna array. In a specific implementation process, the base station may further include a synchronization unit connected to the first transmission unit and used for forming the first time index and the synchronization signal. The structure of the synchronization unit may include a processor and a storage medium; a computer executable instruction may be stored in the storage medium; the processor forms the synchronization signal and the time index of the synchronization signal by running the computer executable instruction.

The first time index is at least one of the transmission symbol index, the micro-frame index, the sub-frame index and the time domain unit index.

The first transmission unit is arranged to transmit the first time indexes via the system message, the dedicated signaling or the high layer signaling.

The first transmission unit is arranged to: determine the first time index according to the corresponding relationship, configured by the high layer signaling or predefined, between the scrambling bit sequence of the scrambling bit sequence system message of the system message and the first time index, and transmit the first time index borne in the system message; or determine the first time index according to the corresponding relationship, configured by the high layer signaling or predefined, between the CRC scrambling bit sequence of the system message and the first time index, and transmit the first time index borne in the system message; or determine the first time index according to the corresponding relationship, configured by the high layer signaling or predefined, between the combination of the CRC scrambling bit sequence of the system message and the scrambling bit sequence of the system message and the first time index, and transmit the first time index borne in the system message; or determine the first time index according to the corresponding relationship, configured by the high layer signaling or predefined, between the combination of the CRC scrambling bit sequence of the system message and the system message bit and the first time index, and transmit the first time index borne in the system message; or determine the first time index according to the corresponding relationship, configured by the high layer signaling or predefined, between the combination of the scrambling bit sequence of the system message and the system message bit and the first time index, and transmit the first time index borne in the system message; or determine the first time index according to the corresponding relationship, configured by the high layer signaling or predefined, between the combination of the CRC scrambling bit sequence of the system message, the scrambling bit sequence of the system message and the system message bit and the first time index, and transmit the first time index borne in the system message; or determine the first time index according to the corresponding relationship, configured by the high layer signaling or predefined, between the system message bit and the first time index, and transmit the first time index borne in the system message.

In conclusion, this embodiment provides a specific hardware support for the method for determining the transmission time of the synchronization signal in Embodiment 2, may be used for implementing any one of the technical solutions in method Embodiment 1, and similarly has the advantages that the synchronization accuracy between the terminal and the base station is improved and the synchronization is simplified.

### Embodiment 8

As shown in FIG. 7, this embodiment provides a base station, the base station includes:

a second determination unit 210, arranged to determine the transmission parameter according to the corresponding relationship between different synchronization signals and time indexes; and

a second transmission unit 220, arranged to transmit the downlink signal including the synchronization signal according to the transmission parameter,

herein the transmission parameter is used for representing the time index; and

the time index is a time index used for a terminal to determine a transmission time of the synchronization signal.

In this embodiment, a specific structure of the second determination unit 210 may include a processor and a memory; the memory stores the corresponding relationship between different synchronization signals and the second time index; the processor is connected to the memory, and when the transmission parameter is determined, the memory is read according to a parameter such as the synchronization signal currently needed to be transmitted, so as to form the transmission parameter.

The specific structure of the second transmission unit 220 may be a transmission antenna or a transmission antenna array, specifically, for example, a Massive antenna array, arranged to transmit the synchronization signal and the second time index according to the transmission parameter.

The transmission parameter may be a parameter such as a transmission time interval between two signals, and may be different according to different signal transmission times, specifically including the following modes.

Mode 1:

The time index is the second time index, the synchronization signal includes a main synchronization signal and an auxiliary synchronization signal;

the transmission time interval between the main synchronization signal and the auxiliary synchronization signal is the first time interval;

the transmission parameter is the first time interval; the time index is the second time index; and

the first time interval is represented as the second time index;

herein the corresponding relationship between the first time interval and the second time index is configured by the high layer signaling or predefined.

Mode 2:

N1 synchronization signals use S1 different synchronization sequences, herein N1≧S1>0;

the transmission parameter is the synchronization sequence; and the time index is the second time index;

herein the corresponding relationship between the synchronization sequence and the second time index is configured by the high layer signaling or predefined.

Mode 3:

The downlink signal further includes the discovery signal; the transmission parameter is the beam index borne by the discovery signal; the time index is the third time index; and

the corresponding relationship between the beam index and the third time index is configured by the high layer signaling or predefined.

Mode 4:

The downlink signal further includes the discovery signal;

the transmission parameter is the discovery sequence of the discovery signal; the time index is the third time index; and

the corresponding relationship between the discovery sequence and the third time index is configured by the high layer signaling or predefined.

Mode 5:

The downlink signal further includes the discovery signal;

the transmission time interval between the synchronization signal and the discovery signal is the second time interval;

the transmission parameter is the second time interval; the time index is the fourth time index; and

the corresponding relationship between the second time interval and the fourth time index is configured by the high layer signaling or predefined.

Mode 6:

The transmission parameter is the synchronization signal index of the synchronization signal and the discovery signal index of the discovery signal; the time index is fourth time index; and

the corresponding relationship between the combination of the synchronization signal index and the discovery signal index and the fourth time index is configured by the high layer signaling or predefined.

Mode 7:

The transmission parameter includes the synchronization signal index, the discovery signal index and the second time interval;

the time index is the fourth time index; and

the corresponding relationship between the combination of the synchronization signal index, the discovery signal index and the second time interval and the fourth time index is configured by the high layer signaling or predefined.

Mode 8:

The second transmission unit is further arranged to transmit the first time index in the time indexes via the system message, the dedicated signaling or the high layer signaling;

the first time index and other time indexes in the time indexes are time indexes cooperatively used for the terminal to determine the transmission time of the synchronization signal; specifically, for example, the first time index and the time index in any solution in Mode 1 to Mode 7 jointly constitute an index used for indicating the transmission time of the synchronization signal.

The terminal of this embodiment provides a hardware support for the method for determining the transmission time of the synchronization signal in Embodiment 3, it may be used for implementing any technical solution of the method for determining the transmission time of the synchronization signal in Embodiment 3, and similarly has the advantages of accurate synchronization and easy implementation.

### Embodiment 9

As shown in FIG. 8, this embodiment provides a communication system, the system includes:

a base station 310, arranged to transmit a synchronization signal and a first time index; herein the first time index is arranged to indicate transmission time of the synchronization signal; and

a terminal 320, arranged to receive the synchronization signal and the first time index and determine the transmission time of the synchronization signal according to the first time index.

The communication system of this embodiment transmits not only the synchronization signal but also the time index of each synchronization signal between the base station and the terminal, such that the terminal may accurately acquire the transmission time of the synchronization signal according to the synchronization signal and the time index, thereby realizing accurate synchronization, and is particularly applicable to an application scenario where the base station will transmit a plurality of synchronization signals within a synchronization period. The base station 310 and the terminal 320 are connected via a mobile communication network, and perform information interaction by means of the 2^{nd} generation communication, the 3^{rd} generation communication, the 4^{th} generation communication or the 5^{th} generation communication. The base station 310 may be different according to different mobile communication networks through which the terminal 320 communicates with it, for example, when the base station 310 is connected to the terminal via the 3^{rd} generation communication or n^{th} generation communication (n>3), the base station may be an evolved Node B (eNB); and the terminal may be a mobile communication terminal such as a smart phone or a tablet personal computer.

The communication system of this embodiment provides a hardware support for the method for determining the transmission time of the synchronization signal in Embodiment 4, may be used for implementing any technical solution of the method in the embodiment, and similarly has the advantages of high synchronization accuracy and easy implementation.

Specifically, the composition and indication mode of the first time index and a bearing mode in a transmission process may refer to the corresponding parts in Embodiment 1, which will not be elaborated herein. In a specific implementation process, the base station may transmit the synchronization signal according to a mode pre-agreed with the terminal, determine the transmission parameter before transmitting the synchronization signal, and transmit the downlink of the synchronization signal to the terminal according to the transmission parameter, the terminal forms the third time index for determining the transmission time of the synchronization signal according to the first time index and the transmission parameter of the downlink signal, and determine the transmission time of the synchronization signal according to the third time index. A specific implementation mode may refer to the corresponding parts in Embodiment 1 and Embodiment 3, which will not be elaborated herein.

The communication system of this embodiment of the present document provides a hardware support for the method in Embodiment 4, may be arranged to implement any technical solution for any method in Embodiment 4, and similarly has the advantages of easy implementation and high accuracy.

### Embodiment 10

This embodiment also provides a communication system, the system includes:

a base station, arranged to determine the transmission parameter according to the corresponding relationship between different synchronization signals and time indexes; and transmit the downlink signal including the synchronization signal according to the transmission parameter; herein the transmission parameter is arranged to represent the time index; and the time index is a time index used for a terminal to determine the transmission time of the synchronization signal; and

a terminal, arranged to receive the downlink signal including the synchronization signal; acquire the transmission parameter of the downlink signal, herein the transmission parameter is the time index; and determine the transmission time of the synchronization signal according to the time index.

In the communication system of this embodiment, the synchronization signal is transmitted between the base station and the terminal; and the synchronization signal is formed and transmitted in a pre-agreed mode; therefore, when transmitting the downlink signal including the synchronization signal, the base station forms the transmission parameter firstly according to contents pre-agreed with the terminal; and the terminal may accurately acquire the transmission time of the synchronization signal according to the synchronization signal and the second time index formed on the basis of the transmission parameter, thereby realizing accurate synchronization. The system is particularly applied to an application scenario where the base station will transmit a plurality of synchronization signals within a synchronization period. The base station and the terminal are connected via a mobile communication network, and perform information interaction via the 2^{nd} generation communication, the 3^{rd} generation communication, the 4^{th} generation communication or the 5^{th} generation communication. The base station may be different according to different mobile communication networks through which the terminal 320 communicates with it, for example, when the base station is connected to the terminal via the 3^{rd} generation communication or n^{th} generation communication (n>3), the base station may be an eNB; and the terminal may be a mobile communication terminal such as a smart phone or a tablet personal computer.

The communication system of this embodiment of the present document provides a hardware support for the method in Embodiment 5, may be used for implementing any technical solution for any method in Embodiment 5, and similarly has the advantages of easy implementation and high accuracy.

In an embodiment of the present document, a computer storage medium is also recited, and computer executable instructions are stored in the computer storage medium, the computer executable instructions are arranged to execute at least one of the methods in the embodiments of the present document; specifically, for example, the method shown in one or more of FIG. 1, FIG. 2, FIG. 4 and FIG. 5.

The computer storage medium may be: various media capable of storing program codes such as a mobile storage device, a Read-Only Memory (ROM), a Random Access Memory (RAM), a magnetic disc or an optical disc; and optionally is a non-instant storage medium.

Several specific examples are provided in conjunction with any one of the above embodiments as follows.

### Example 1

As shown in FIG. 9, it is assumed that the base station transmits, by using N downlink beams, at least one of the following signals and/or information: a downlink synchronization signal, a downlink discovery signal and downlink system information.

In FIG. 9, within a time block indicated by 101, the base station transmits beam 0; within a time block indicated by 102, the base station transmits beam 1; within a time block indicated by 103, the base station transmits beam 2; within a time block indicated by 104, the base station transmits beam 3; within a time block indicated by 105, the base station transmits beam 4; and within a time block indicated by 106, the base station transmits beam 5; herein an Nms-time interval may be regarded as a synchronization period.

The above time blocks may be a sub-frames, a micro-frame, a transmission unit or a self-defined time domain unit. In conjunction with FIG. 9, when transmitting the synchronization signal, the base station indicates a transmission beam of the corresponding time domain unit via the synchronization signal, and indicates the downlink synchronization signal at the same time. The base station pre-defines that a plurality of synchronization signals are transmitted over the same time domain unit X using a plurality of sequences.

The terminal detects the plurality of synchronization signals at a plurality of time domain unit positions using a plurality of synchronization signal sequences, and when the terminal detects, over the corresponding time domain unit X, that the synchronization signal meets a certain threshold requirement and the corresponding synchronization signal sequence index is Y, the terminal may obtain a beam index according to the index Y, and may obtain timing synchronization according to the time domain unit. For example, the time domain unit X is predefined to be on a 0^{th} micro-frame of a 5 ms-time interval, and in this case, the terminal may obtain all corresponding timing relationships.

### Example 2

It is assumed that the base station transmits, by using N downlink beams on a carrier, at least one of the following signals and information: the downlink synchronization signal, the downlink discovery signal and the downlink system information, as shown in FIG. 9. When transmitting the synchronization signal on the carrier, the base station indicates synchronization information by the synchronization signal. The base station predefines, on the carrier, that a plurality of synchronization signals are transmitted over a plurality of time domain units in a time division mode, for example, Table 1. The base station informs a terminal of a time domain unit corresponding to the synchronization signal being detected through the CRC scrambling bit of the system message on the carrier, thereby indicating the terminal to perform synchronization operation, and the system message and the synchronization signal are in a corresponding relationship, and have a predefined time domain and/or frequency domain position difference.

TABLE 1

| Synchronization signal | Time domain unit |
|---|---|
| 0 | Time domain unit index 0 |
| 1 | Time domain unit index 1 |
| . . . | . . . |
| X | Time domain unit index X |

The terminal obtains a synchronization signal meeting the threshold requirement by detecting synchronization signals on the carrier, and detects the system message in accordance with the predefined time domain and/or frequency domain position difference, and obtains, by detecting the CRC scrambling bit sequence of the system message, the synchronization signal and a time domain unit index where the system message is located. Herein, the corresponding relationship between the CRC scrambling bit sequence of the system message and the time domain unit index is predefined, or the corresponding relationship between the CRC scrambling bit sequence of the system message and the time domain unit index on the carrier is configured by a high layer signaling of another base station or carrier, and the corresponding relationship is shown in Table 2.

TABLE 2

| CRC scrambling bit sequence | |
|---|---|
| of the system message | Time domain unit |
| CRC scrambling bit sequence 0 of | Time domain unit index 0 |
| the system message | |
| CRC scrambling bit sequence 1 of | Time domain unit index 1 |
| the system message | |
| . . . | . . . |
| CRC scrambling bit sequence X of | Time domain unit index X |
| the system message | |

### Example 3

It is assumed that the base station transmits, by using N downlink beams on a carrier, at least one of the following signals and information: the downlink synchronization signal, the downlink discovery signal and the downlink system information, as shown in FIG. 9. When transmitting a synchronization signal on the carrier, the base station indicates synchronization information by the synchronization signal. The base station predefines, on the carrier, that a plurality of synchronization signals are transmitted over a plurality of time domain units in a time division mode, for example, Table 1. The base station informs a terminal of a time domain unit corresponding to the synchronization signal being detected through a time domain index indication bit or sequence in the system message on the carrier, thereby indicating the terminal to perform synchronization operation, and the system message and the synchronization signal are in a corresponding relationship, and have a predefined time domain and/or frequency domain position difference.

The terminal obtains a synchronization signal meeting the threshold requirement by detecting synchronization signals on the carrier, and detects the system message in accordance with the predefined time domain and/or frequency domain position difference, and obtains, by detecting the time domain index indication bit or sequence in the system message, the synchronization signal and the time domain unit index where the system message is located. Herein, the corresponding relationship between the time domain index indication bit or bit sequence in the system message and the time domain unit index is predefined, or the corresponding relationship between the time domain index indication bit or bit sequence in the system message and the time domain unit index on the carrier is configured by a high layer signaling of another base station or carrier, and the corresponding relationship is shown in Table 3.

TABLE 3

| Time domain index indication bit or bit | |
|---|---|
| sequence in the system message | Time domain unit |
| Time domain index indication bit or bit | Time domain unit index 0 |
| sequence 0 in the system message | |
| Time domain index indication bit or bit | Time domain unit index 1 |
| sequence 1 in the system message | |
| . . . | . . . |
| Time domain index indication bit or bit | Time domain unit index X |
| sequence X in the system message | |

### Example 4

It is assumed that the base station transmits, by using N downlink beams on a carrier, at least one of the following signals and information: the downlink synchronization signal, the downlink discovery signal and the downlink system information, which may basically cover areas needed to be covered by the base station, as shown in FIG. 9. When transmitting the synchronization signal on the carrier, the base station indicates synchronization information by the synchronization signal. The base station predefines, on the carrier, that a plurality of synchronization signals are transmitted over a plurality of time domain units in a time division mode, for example, Table 1. The base station informs a terminal of a time domain unit corresponding to the synchronization signal being detected through a combination of the time domain index indication bit/sequence in the system message and the CRC scrambling bit sequence of the system message on the carrier, thereby indicating the terminal to perform synchronization operation, and the system message and the synchronization signal are in a corresponding relationship, and have a predefined time domain and/or frequency domain position difference.

The terminal obtains a synchronization signal meeting the threshold requirement by detecting synchronization signals on the carrier, and detects the system message in accordance with the predefined time domain and/or frequency domain position difference, and obtains, by detecting the combination of the time domain index indication bit/sequence in the system message and the CRC scrambling bit sequence of the system message, the synchronization signal and a time domain unit index where the system message is located. Herein, the corresponding relationship between the combination of the time domain index indication bit/sequence in the system message and the CRC scrambling bit sequence of the system message and the time domain unit index is predefined, or the corresponding relationship between the combination of the time domain index indication bit/sequence in the system message and the CRC scrambling bit sequence of the system message and the time domain unit index on the carrier is configured by a high layer signaling of another base station or carrier, and the corresponding relationship is shown in Table 4.

TABLE 4

| Combination of time domain index | |
|---|---|
| indication bit/sequence in the system | |
| message and CRC scrambling bit | |
| sequence of the system message | Time domain unit |
| Combination 0 of time domain index | Time domain unit index 0 |
| indication bit/sequence in the system | |
| message and CRC scrambling bit | |
| sequence of the system message | |
| Combination 1 of time domain index | Time domain unit index 1 |
| indication bit/sequence in the system | |
| message and CRC scrambling bit | |
| sequence of the system message | |
| . . . | . . . |
| Combination X of time domain index | Time domain unit index X |
| indication bit/sequence in the system | |
| message and CRC scrambling bit | |
| sequence of the system message | |

### Example 5

It is assumed that the base station transmits, by using N downlink beams on a carrier, at least one of the following signals and information: the downlink synchronization signal, the downlink discovery signal and the downlink system information, which may basically cover areas needed to be covered by the base station, as shown in FIG. 9. When transmitting the synchronization signal on the carrier, the base station indicates synchronization information by the synchronization signal. The base station predefines, on the carrier, that a plurality of synchronization signals are transmitted over a plurality of time domain units in a time division mode, for example, Table 1. The base station informs a terminal of a time domain unit corresponding to the synchronization signal being detected through the synchronization signal sequence on the carrier, thereby indicating the terminal to perform synchronization operation.

The terminal obtains a synchronization signal meeting the threshold requirement by detecting synchronization signals on the carrier, and obtains a time domain unit corresponding to detection time in accordance with a predefined corresponding relationship between the synchronization signal sequence and the time domain unit index. Herein the corresponding relationship between the synchronization signal sequence and the time domain unit index is predefined, or the corresponding relationship between the synchronization signal sequence and the time domain unit index on the carrier is configured by a high layer signaling of another base station or carrier, and the corresponding relationship is shown in Table 5.

TABLE 5

| Synchronization signal sequence | Time domain unit |
|---|---|
| Synchronization signal sequence 0 | Time domain unit index 0 |
| Synchronization signal sequence 1 | Time domain unit index 1 |
| . . . | . . . |
| Synchronization signal sequence X | Time domain unit index X |

### Example 6

It is assumed that the base station transmits, by using N downlink beams on a carrier, at least one of the following signals and information: the downlink synchronization signal, the downlink discovery signal and the downlink system information, which may basically cover areas needed to be covered by the base station, as shown in FIG. 9. When transmitting the synchronization signal on the carrier, the base station indicates synchronization information by the synchronization signal. The base station predefines, on the carrier, that a plurality of synchronization signals are transmitted over a plurality of time domain units in a time division mode, for example, Table 1. The base station informs a terminal of a time domain unit corresponding to the synchronization signal being detected through a time interval between a main synchronization signal and an auxiliary synchronization signal on the carrier, thereby indicating the terminal to perform synchronization operation.

The terminal obtains a synchronization signal meeting the threshold requirement by detecting synchronization signals on the carrier, and, in accordance with a predefined corresponding relationship between the time interval between the main synchronization signal and the auxiliary synchronization signal and a time domain unit index, obtains a time domain unit corresponding to the detection time by the corresponding relationship between the time interval between the main synchronization signal and the auxiliary synchronization signal and the time domain unit index. Herein, the corresponding relationship between the time interval between the main synchronization signal and the auxiliary synchronization signal and the time domain unit index is predefined, or the corresponding relationship between the time interval between the main synchronization signal and the auxiliary synchronization signal and the time domain unit index on the carrier is configured by a high layer signaling of another base station or carrier, and the corresponding relationship is shown in Table 6.

TABLE 6

| Type of the time interval between the | |
|---|---|
| main synchronization signal and the | |
| auxiliary synchronization signal | Time domain unit |
| Type 0 of the time interval between the main | Time domain unit index 0 |
| synchronization signal and the auxiliary | |
| synchronization signal | |
| Type 1 of the time interval between the main | Time domain unit index 1 |
| synchronization signal and the auxiliary | |
| synchronization signal | |
| . . . | . . . |
| Type X of the time interval between the | Time domain unit index X |
| main synchronization signal and the | |
| auxiliary synchronization signal | |

### Example 7

It is assumed that the base station transmits, by using N downlink beams on a carrier, at least one of the following signals and information: the downlink synchronization signal, the downlink discovery signal and the downlink system information, which may basically cover areas needed to be covered by the base station, as shown in FIG. 9. When transmitting a synchronization signal on the carrier, the base station indicates synchronization information by the synchronization signal. The base station predefines, on the carrier, that a plurality of synchronization signals are transmitted over a plurality of time domain units in a time division mode, for example, Table 1. The base station informs a terminal of a time domain unit corresponding to the synchronization signal being detected through a time interval between a downlink synchronization signal and a downlink discovery signal on the carrier, thereby indicating the terminal to perform synchronization operation.

The terminal obtains a synchronization signal meeting the threshold requirement by detecting synchronization signals on the carrier, and, in accordance with a predefined corresponding relationship between the time interval between the downlink synchronization signal and the downlink discovery signal and the time domain unit index, obtains a time domain unit corresponding to the detection time by the corresponding relationship between the time interval between the downlink synchronization signal and the downlink discovery signal and the time domain unit index. Herein, the corresponding relationship between the time interval between the downlink synchronization signal and the downlink discovery signal and the time domain unit index is predefined, or the corresponding relationship between the time interval between the downlink synchronization signal and the downlink discovery signal and the time domain unit index on the carrier is configured by a high layer signaling of another base station or carrier, and the corresponding relationship is shown in Table 7.

TABLE 7

| Type of the time interval between the | |
|---|---|
| downlink synchronization signal and | |
| downlink discovery signal | Time domain unit |
| Type 0 of the time interval between the | Time domain unit index 0 |
| downlink synchronization signal and | |
| downlink discovery signal | |
| Type 1 of the time interval between the | Time domain unit index 1 |
| downlink synchronization signal and | |
| downlink discovery signal | |
| . . . | . . . |
| Type X of the time interval between the | Time domain unit index X |
| downlink synchronization signal and | |
| downlink discovery signal | |

### Example 8

It is assumed that the base station transmits, by using N downlink beams on a carrier, at least one of the following signals and information: the downlink synchronization signal, the downlink discovery signal and the downlink system information, which may basically cover areas needed to be covered by the base station, as shown in FIG. 9. When transmitting a synchronization signal on the carrier, the base station indicates synchronization information by the synchronization signal. The base station predefines, on the carrier, that a plurality of synchronization signals are transmitted over a plurality of time domain units in a time division mode, for example, Table 1. The base station informs a terminal of a time domain unit corresponding to the synchronization signal being detected through a combination of the synchronization signal sequence and the time interval between the downlink synchronization signal and the downlink discovery signal on the carrier, thereby indicating the terminal to perform synchronization operation.

The terminal obtains a synchronization signal meeting the threshold requirement by detecting synchronization signals on the carrier, and in accordance with a predefined corresponding relationship between the combination of the synchronization signal sequence and the time interval between the downlink synchronization signal and the downlink discovery signal and the time domain unit index, obtains a time domain unit corresponding to detection time by the corresponding relationship between the combination of the synchronization signal sequence and the time interval between the downlink synchronization signal and the downlink discovery signal and the time domain unit index. Herein, the corresponding relationship between the combination of the synchronization signal sequence and the time interval between the downlink synchronization signal and the downlink discovery signal and the time domain unit index is predefined, or the corresponding relationship between the combination of the synchronization signal sequence and the time interval between the downlink synchronization signal and the downlink discovery signal and the time domain unit index on the carrier is configured by a high layer signaling of another base station or carrier, and the corresponding relationship is shown in Table 8.

TABLE 8

| Combination of the synchronization signal | |
|---|---|
| sequence and the time interval between the | |
| downlink synchronization signal and the | |
| downlink discovery signal | Time domain unit |
| Combination 0 of the synchronization signal | Time domain unit index 0 |
| sequence and the time interval between the | |
| downlink synchronization signal and the | |
| downlink discovery signal | |
| Combination 1 of the synchronization signal | Time domain unit index 1 |
| sequence and the time interval between the | |
| downlink synchronization signal and the | |
| downlink discovery signal | |
| . . . | . . . |
| Combination X of the synchronization signal | Time domain unit index X |
| sequence and the time interval between the | |
| downlink synchronization signal and the | |
| downlink discovery signal | |

### Example 9

It is assumed that the base station transmits, by using N downlink beams on a carrier, at least one of the following signals and information: the downlink synchronization signal, the downlink discovery signal and the downlink system information, which may basically cover areas needed to be covered by the base station, as shown in FIG. 9. When transmitting a synchronization signal on the carrier, the base station indicates synchronization information by the synchronization signal. The base station predefines, on the carrier, that a plurality of synchronization signals are transmitted over a plurality of time domain units in a time division mode, for example, Table 1. The base station informs a terminal of a time domain unit corresponding to the synchronization signal being detected through the combination of the synchronization signal sequence and the time interval between a main synchronization signal and an auxiliary synchronization signal on the carrier, thereby indicating the terminal to perform synchronization operation.

The terminal obtains a synchronization signal meeting the threshold requirement by detecting synchronization signals on the carrier, and in accordance with a predefined corresponding relationship between the combination of the synchronization signal sequence and the time interval between the main synchronization signal and the auxiliary synchronization signal and the time domain unit index, obtains a time domain unit corresponding to the detection time by the corresponding relationship between the combination of the synchronization signal sequence and the time interval between the main synchronization signal and the auxiliary synchronization signal and the time domain unit index. Herein, the corresponding relationship between the combination of the synchronization signal sequence and the time interval between the main synchronization signal and the auxiliary synchronization signal and the time domain unit index is predefined, or the corresponding relationship between the combination of the synchronization signal sequence and the time interval between the main synchronization signal and the auxiliary synchronization signal and the time domain unit index on the carrier is configured by a high layer signaling of another base station or carrier, and the corresponding relationship is shown in Table 8.

TABLE 9

| Combination of the synchronization signal | |
|---|---|
| sequence and the time interval between the | |
| main synchronization signal and the auxiliary | |
| synchronization signal | Time domain unit |
| Combination 0 of the synchronization signal | Time domain unit index 0 |
| sequence and the time interval between the | |
| main synchronization signal and the auxiliary | |
| synchronization signal | |
| Combination 1 of the synchronization signal | Time domain unit index 1 |
| sequence and the time interval between the | |
| main synchronization signal and the auxiliary | |
| synchronization signal | |
| . . . | . . . |
| Combination X of the synchronization signal | Time domain unit index X |
| sequence and the time interval between the | |
| main synchronization signal and the auxiliary | |
| synchronization signal | |

The above is only the optional embodiments of the present document, and is not arranged to limit the protection scope of the present document. Any modifications made in accordance with the principle of the present document shall be interpreted as falling within the protection scope of the present document.

What is claimed is:

1. A method for determining a transmission time of a synchronization signal, comprising:
receiving a synchronization signal;
acquiring a time index of the synchronization signal; and
determining a transmission time of the synchronization signal according to the time index.

2. The method according to claim 1, wherein,
the time index is a first time index, a second time index, a third time index, a fourth time index, a fifth time index, a sixth time index or a seventh time index;
said acquiring a time index of the synchronization signal is:
acquiring the first time index transmitted by a base station via a system message, a dedicated signaling or a high layer signaling;
or
acquiring the second time index according to a synchronization signal transmitted by the base station;
or
acquiring the third time index according to a discovery signal transmitted by the base station;
or
acquiring the fourth time index according to the synchronization signal and the discovery signal transmitted by the base station;
or
acquiring the fifth time index according to the first time index and the second time index;
or
acquiring the sixth time index according to the first time index and the third time index;
or
acquiring the seventh time index according to the first time index and the fourth time index.

3. The method according to claim 2, wherein
said acquiring the first time index transmitted by a base station via a system message is:
determining the first time index according to a corresponding relationship, configured by the high layer signaling or predefined, between a scrambling bit sequence of the system message and the first time index;
or
determining the first time index according to a corresponding relationship, configured by the high layer signaling or predefined, between a Cyclic Redundancy Check, CRC, scrambling bit sequence of the system message and the first time index;
or
determining the first time index according to a corresponding relationship, configured by the high layer signaling or predefined, between a combination of the CRC scrambling bit sequence of the system message and the scrambling bit sequence of the system message and the first time index;
or
determining the first time index according to a corresponding relationship, configured by the high layer signaling or predefined, between a combination of the CRC scrambling bit sequence of the system message and a system message bit and the first time index;
or
determining the first time index according to a corresponding relationship, configured by the high layer signaling or predefined, between a combination of the scrambling bit sequence of the system message and the system message bit and the first time index;
or
determining the first time index according to a corresponding relationship, configured by the high layer signaling or predefined, between a combination of the CRC scrambling bit sequence of the system message, the scrambling bit sequence of the system message and the system message bit and the first time index;
or
determining the first time index according to a corresponding relationship, configured by the high layer signaling or predefined, between the system message bit and the first time index.

4. The method according to claim 2, wherein,
one said synchronization signal comprises a main synchronization signal and an auxiliary synchronization signal;
said receiving a synchronization signal is:
receiving the main synchronization signal and the auxiliary synchronization signal respectively;
said acquiring the second time index according to a synchronization signal transmitted by the base station comprises:
determining a transmission time interval between the main synchronization signal and the auxiliary synchronization signal according to a receiving time interval between the main synchronization signal and the auxiliary synchronization signal, wherein the transmission time interval is a first time interval; and
determining the second time index according to a corresponding relationship, configured by the high layer signaling or predefined, between the first time interval and the second time index.

5. The method according to claim 2, wherein,
N1 said synchronization signals use S1 different synchronization sequences, wherein N1≧S1>0;
said acquiring the second time index according to a synchronization signal transmitted by the base station comprises:
extracting a synchronization sequence corresponding to the synchronization signal; and
determining the second time index according to a corresponding relationship, configured by the high layer signaling or predefined, between the synchronization sequence and the second time index.

6. The method according to claim 2, wherein,
said acquiring the third time index according to a discovery signal transmitted by the base station comprises:
receiving the discovery signal;
extracting a discovery sequence corresponding to the discovery signal; and
determining the third time index according to a corresponding relationship, configured by the high layer signaling or predefined, between the discovery sequence and the third time index;
wherein N2 said discovery signals use S2 different discovery sequences, and N2≧S2>0.

7. The method according to claim 2, wherein,
said acquiring the third time index according to a discovery signal transmitted by the base station comprises:
receiving the discovery signal, wherein the discovery signal bears a beam index; and
determining the third time index according to a corresponding relationship, configured by the high layer signaling or predefined, between the beam index and the third time index.

8. The method according to claim 2, wherein,
the method further comprises: receiving the discovery signal;
said acquiring the fourth time index according to the synchronization signal and the discovery signal transmitted by the base station comprises:
determining a transmission time interval between the synchronization signal and the discovery signal according to a receiving time interval between the synchronization signal and the discovery signal, wherein the transmission time interval is a second time interval;
determining the fourth time index according to a corresponding relationship, configured by the high layer signaling or predefined, between the second time interval of the synchronization signal and the discovery signal and the second time index;
or
determining a synchronization signal index according to the synchronization signal;
determining a discovery signal index according to the discovery signal;
determining the fourth time index according to a corresponding relationship, configured by the high layer signaling or predefined, between a combination of the synchronization signal index and the discovery signal index and the fourth time index;
or,
determining the synchronization signal index according to the synchronization signal;
determining the discovery signal index according to the discovery signal;
determining the transmission time interval between the synchronization signal and the discovery signal, wherein the time interval is the second time interval;
determining the fourth time index according to a corresponding relationship, configured by the high layer signaling or predefined, between a combination of a synchronization signal sequence index, the discovery signal index and the second time interval and the second time index.

9. (canceled)

10. A method for determining a transmission time of a synchronization signal, comprising:
transmitting a synchronization signal; and
transmitting a first time index of the synchronization signal,
wherein the first time index is arranged to determine the transmission time of the synchronization signal.

11. The method according to claim 10, wherein,
said transmitting a first time index of the synchronization signal is:
transmitting the first time index via a system message, dedicated information or a high layer signaling,
and
wherein,
said transmitting the first time index via the system message is:
determining the first time index according to a corresponding relationship, configured by the high layer signaling or predefined, between a scrambling bit sequence of the system message and the first time index, and transmitting the first time index borne in the system message;
or
determining the first time index according to a corresponding relationship, configured by the high layer signaling or predefined, between a CRC scrambling bit sequence of the system message and the first time index, and transmitting the first time index borne in the system message;
or
determining the first time index according to a corresponding relationship, configured by the high layer signaling or predefined, between a combination of the CRC scrambling bit sequence of the system message and the scrambling bit sequence of the system message and the first time index, and transmitting the first time index borne in the system message;
or
determining the first time index according to a corresponding relationship, configured by the high layer signaling or predefined, between a combination of the CRC scrambling bit sequence of the system message and a system message bit and the first time index, and transmitting the first time index borne in the system message;
or
determining the first time index according to a corresponding relationship, configured by the high layer signaling or predefined, between a combination of the scrambling bit sequence of the system message and the system message bit and the first time index, and transmitting the first time index borne in the system message;
or
determining the first time index according to a corresponding relationship, configured by the high layer signaling or predefined, between a combination of the CRC scrambling bit sequence of the system message, the scrambling bit sequence of the system message and the system message bit and the first time index, and transmitting the first time index borne in the system message;
or
determining the first time index according to a corresponding relationship, configured by the high layer signaling or predefined, between the system message bit and the first time index, and transmitting the first time index borne in the system message.

12. (canceled)

13. A method for determining a transmission time of a synchronization signal, comprising:
determining a transmission parameter according to a corresponding relationship between different synchronization signals and time indexes; and
transmitting a downlink signal comprising the synchronization signal according to the transmission parameter,
wherein the transmission parameter is arranged to represent the time index; and
the time index is a time index arranged for a terminal to determine a transmission time of the synchronization signal.

14. The method according to claim 13, wherein,
the time index is a second time index;
one said synchronization signal comprises a main synchronization signal and an auxiliary synchronization signal;
a transmission time interval between the main synchronization signal and the auxiliary synchronization signal is a first time interval;
the transmission parameter is the first time interval; the time index is the second time index; and
the first time interval is represented as the second time index;
wherein a corresponding relationship between the first time interval and the second time index is configured by a high layer signaling or predefined.

15. The method according to claim 13, wherein,
N1 said synchronization signals use S1 different synchronization sequences, wherein N1≧S1>0;
the transmission parameter is the synchronization sequence, and the time index is the second time index,
wherein a corresponding relationship between the synchronization sequence and the second time index is configured by the high layer signaling or predefined.

16. (canceled)

17. (canceled)

18. (canceled)

19. (canceled)

20. A method for determining a transmission time of a synchronization signal, comprising:
transmitting, by a base station, a synchronization signal;
receiving, by a terminal, the synchronization signal;
transmitting, by the base station, a first time index; wherein the first time index is arranged to indicate the transmission time of the synchronization signal;
receiving, by the terminal, the first time index; and
determining, by the terminal, the transmission time of the synchronization signal according to the first time index.

21. A method for determining a transmission time of a synchronization signal, comprising:
determining, by a base station, a transmission parameter according to a corresponding relationship between different synchronization signals and time indexes;
transmitting, by the base station, a downlink signal comprising the synchronization signal according to the transmission parameter;
wherein the transmission parameter is arranged to represent the time index; and
the time index is a time index arranged for the terminal to determine a transmission time of the synchronization signal;
receiving, by the terminal, the downlink signal comprising the synchronization signal;
acquiring, by the terminal, the transmission parameter of the downlink signal, and determining the time index according to the transmission parameter; and
determining, by the terminal, the transmission time of the synchronization signal according to the time index.

22. A terminal, comprising:
a receiving unit, arranged to receive a synchronization signal;
an acquisition unit, arranged to acquire a time index of the synchronization signal; and
a first determination unit, arranged to determine a transmission time of the synchronization signal according to the time index.

23. The terminal according to claim 22, wherein,
the time index is a first time index, a second time index, a third time index, a fourth time index, a fifth time index, a sixth time index or a seventh time index;
the acquisition unit is arranged to:
acquire the first time index transmitted by a base station via a system message, a dedicated signaling or a high layer signaling;
or
acquire the second time index according to a synchronization signal transmitted by the base station;
or
acquire the third time index according to a discovery signal transmitted by the base station;
or
acquire the fourth time index according to the synchronization signal and the discovery signal transmitted by the base station;
or
acquire the fifth time index according to the first time index and the second time index;
or
acquire the sixth time index according to the first time index and the third time index;
or
acquire the seventh time index according to the first time index and the fourth time index.

24. The terminal according to claim 23, wherein
the acquisition unit is arranged to:
determine the first time index according to a corresponding relationship, configured by the high layer signaling or predefined, between a scrambling bit sequence of the system message and the first time index;
or
determine the first time index according to a corresponding relationship, configured by the high layer signaling or predefined, between a CRC scrambling bit sequence of the system message and the first time index;
or
determine the first time index according to a corresponding relationship, configured by the high layer signaling or predefined, between a combination of the CRC scrambling bit sequence of the system message and the scrambling bit sequence of the system message and the first time index;
or
determine the first time index according to a corresponding relationship, configured by the high layer signaling or predefined, between a combination of the CRC scrambling bit sequence of the system message and a system message bit and the first time index;
or
determine the first time index according to a corresponding relationship, configured by the high layer signaling or predefined, between a combination of the scrambling bit sequence of the system message and the system message bit and the first time index;
or
determine the first time index according to a corresponding relationship, configured by the high layer signaling or predefined, between a combination of the CRC scrambling bit sequence of the system message, the scrambling bit sequence of the system message and the system message bit and the first time index;
or
determine the first time index according to a corresponding relationship, configured by the high layer signaling or predefined, between the system message bit and the first time index.

25. (canceled)

26. (canceled)

27. (canceled)

28. (canceled)

29. (canceled)

30. (canceled)

31. A base station, comprising:
a first transmission unit, arranged to transmit a synchronization signal and a first time index,
wherein the first time index is arranged for a terminal to determine a transmission time of the synchronization signal.

32. The base station according to claim 31, wherein,
the first transmission unit is arranged to transmit the first time index via a system message, dedicated information or a high layer signaling.

33. The base station according to claim 32, wherein
the first transmission unit is arranged to: determine the first time index according to a corresponding relationship, configured by the high layer signaling or predefined, between a scrambling bit sequence of the system message and the first time index, and transmit the first time index borne in the system message;
or
determine the first time index according to a corresponding relationship, configured by the high layer signaling or predefined, between a CRC scrambling bit sequence of the system message and the first time index, and transmit the first time index borne in the system message;
or
determine the first time index according to a corresponding relationship, configured by the high layer signaling or predefined, between a combination of the CRC scrambling bit sequence of the system message and the scrambling bit sequence of the system message and the first time index, and transmit the first time index borne in the system message;
or
determine the first time index according to a corresponding relationship, configured by the high layer signaling or predefined, between a combination of the CRC scrambling bit sequence of the system message and a system message bit and the first time index, and transmit the first time index borne in the system message;
or
determine the first time index according to a corresponding relationship, configured by the high layer signaling or predefined, between a combination of the scrambling bit sequence of the system message and the system message bit and the first time index, and transmit the first time index borne in the system message;
or
determine the first time index according to a corresponding relationship, configured by the high layer signaling or predefined, between a combination of the CRC scrambling bit sequence of the system message, the scrambling bit sequence of the system message and the system message bit and the first time index, and transmit the first time index borne in the system message;
or
determine the first time index according to a corresponding relationship, configured by the high layer signaling or predefined, between the system message bit and the first time index, and transmit the first time index borne in the system message.

34. A base station, comprising:
a second determination unit, arranged to determine a transmission parameter according to a corresponding relationship between different synchronization signals and time indexes;
a second transmission unit, arranged to transmit a downlink signal comprising the synchronization signal according to the transmission parameter;
wherein the transmission parameter is arranged to represent the time index;
the time index is a time index arranged for a terminal to determine a transmission time of the synchronization signal.

35. The base station according to claim 34, wherein,
the time index is a second time index;
one said synchronization signal comprises a main synchronization signal and an auxiliary synchronization signal;
a transmission time interval between the main synchronization signal and the auxiliary synchronization signal is a first time interval;
the transmission parameter is the first time interval; the time index is the second time index; and
the first time interval is represented as the second time index;
wherein a corresponding relationship between the first time interval and the second time index is configured by a high layer signaling or predefined.

36. (canceled)

37. (canceled)

38. (canceled)

39. (canceled)

40. (canceled)

41. A communication system, comprising:
a base station, arranged to transmit a synchronization signal and a first time index; wherein the first time index is arranged to indicate transmission time of the synchronization signal; and
a terminal, arranged to receive the synchronization signal and the first time index and determine the transmission time of the synchronization signal according to the first time index.

42. A communication system, the system comprising:
a base station, arranged to determine a transmission parameter according to a corresponding relationship between different synchronization signals and time indexes, and transmit a downlink signal comprising the synchronization signal according to the transmission parameter; wherein the transmission parameter is arranged to represent the time index, and the time index is a time index arranged for a terminal to determine a transmission time of the synchronization signal; and
the terminal, arranged to receive the downlink signal comprising the synchronization signal; acquire the transmission parameter of the downlink signal, determine the time index according to the transmission parameter; and determine the transmission time of the synchronization signal according to the time index.

43. A computer storage medium, in which computer executable instructions are stored, wherein the computer executable instructions are arranged to execute the method according to claim 1.

44. A computer storage medium, in which computer executable instructions are stored, wherein the computer executable instructions are arranged to execute the method according to claim 10.

45. A computer storage medium, in which computer executable instructions are stored, wherein the computer executable instructions are arranged to execute the method according to claim 13.

46. A computer storage medium, in which computer executable instructions are stored, wherein the computer executable instructions are arranged to execute the method according to claim 20.

47. A computer storage medium, in which computer executable instructions are stored, wherein the computer executable instructions are arranged to execute the method according to claim 21.
